(19) United States
(12) Patent Application Publication
(10) Pub. No.: US 2023/0206402 A1
(43) Pub. Date: Jun. 29, 2023

(54) CONTEXT AWARE OBJECT GEOTAGGING

(71) Applicant: The Provost, Fellows, Foundation Scholars and the other members of Board of the College of the Holy, Dublin (IE)

(72) Inventors: CHAO-JUNG LIU, Dublin (IE); MATEJ ULICNÝ, Bratislava (SK); ROZENN DAHYOT, Dublin (IE)

(21) Appl. No.: 18/087,227

(22) Filed: Dec. 22, 2022

Related U.S. Application Data
(60) Provisional application No. 63/293,527, filed on Dec. 23, 2021.

(51) Int. Cl. G06T 5/00; G06T 7/73

(52) U.S. Cl. CPC G06T 5/002; G06T 7/74; G06T 2207/30244; G06T 2207/20021

(57) ABSTRACT

Methods, apparatuses, and computer readable storage mediums for context aware geotagging of objects is disclosed. In a particular embodiment, a method of context aware geotagging of objects includes receiving a set of N panoramic images captured with metadata associated with each image where the metadata for an image indicates a camera position of a camera. In this example embodiment, the method further includes denoising the metadata associated with at least one of the images and providing the denoised metadata to a Markov Random Field (MRF) module to generate a list of GPS coordinates for one or more objects of interest. The method of this example embodiment further includes using context information extracted from Open Street Map (OSM) data to refine the generated list from the MRF module.

### BACKGROUND

Monitoring public assets is a labor-consuming task and for many decades, solutions collecting street view imagery have been routinely deployed in combination with computer vision-based approaches for object detection and recognition in images. Nowadays, street view images are available in massive amounts (e.g.: Mapillary1, Google Street View (GSV)2) and additional information about the scene can be further extracted by machine learning techniques. Researchers have deployed deep learning modules for segmenting objects of interest (e.g., poles) in images and estimating their distance from the camera, and a Markov Random Field (MRF) is then used as a decision module to provide a usable list of the GPS coordinates of the assets of interest, limiting duplicates by reconciling detection from multiple view images. (see Vladimir A. Krylov and Rozenn Dahyot, “Object geolocation using MRF based multi-sensor fusion” in 2018 25th IEEE International Conference on Image Processing (ICIP), pages 2745-2749) (see also Vladimir A. Krylov, Eamonn Kenny, and Rozenn Dahyot, “Automatic discovery and geotagging of objects from street view imagery”. Remote Sensing, 10(5), 2018.)

The MRF conveniently merges information extracted from images and their metadata i.e. their associated camera location (GPS) and bearing information (cf. FIG. 1). Currently, the pipeline of Krylov et al. assumes that the metadata associated with the camera view pose is noiseless, however, it is not always the case (e.g. due to GPS receiver imprecision) and consequently, this noise affects the accuracy of the geo-location of the assets found.

### SUMMARY

Methods, apparatuses, and computer readable storage mediums for context aware geotagging of objects is disclosed. In a particular embodiment, a method of context aware geotagging of objects includes receiving a set of N panoramic images captured with metadata associated with each image where the metadata for an image indicates a camera position of a camera. In this example embodiment, the method further includes denoising the metadata associated with at least one of the images and providing the denoised metadata to a Markov Random Field (MRF) module to generate a list of GPS coordinates for one or more objects of interest. The method of this example embodiment further includes using context information extracted from Open Street Map (OSM) data to refine the generated list from the MRF module.

In another embodiment, an apparatus for context aware geotagging of objects is disclosed in which the apparatus comprises a computer processor and computer readable storage medium that includes computer program instructions that when executed by the computer processor cause the computer processor to carry out the operations of: receiving a set of N panoramic images captured with metadata associated with each image, the metadata for an image indicating a camera position of a camera; denoising the metadata associated with at least one of the images; providing the denoised metadata to a Markov Random Field (MRF) module to generate a list of GPS coordinates for one or more objects of interest; and using context information extracted from Open Street Map (OSM) data to refine the generated list from the MRF module.

In another embodiment, a computer readable storage medium for context aware geotagging of objects is disclosed in which the computer readable storage medium includes computer program instructions that when executed by a computer processor cause the computer processor to carry out the operations of: receiving a set of N panoramic images captured with metadata associated with each image, the metadata for an image indicating a camera position of a camera; denoising the metadata associated with at least one of the images; providing the denoised metadata to a Markov Random Field (MRF) module to generate a list of GPS coordinates for one or more objects of interest; and using context information extracted from Open Street Map (OSM) data to refine the generated list from the MRF module.

In a particular embodiment, denoising the metadata includes splitting each panoramic image into at least two images with overlapping views; identifying matching features extracted from the split panoramic images; and using the identified matching features to calibrate the camera positions of the split images. Using the identified matching features to calibrate the camera positions of the split images may include establishing a geometry relationship between at least two split images. Using the identified matching features to calibrate the camera positions of the split images may also include adjusting at least one of bearing information and position information associated with the split image.

In a particular embodiment, providing the denoised metadata to the MRF module to generate the list of GPS coordinates for the one or more objects of interest includes: using a deep learning pipeline to segment the one or more objects of interest and estimate their distance from the camera; and using the estimated distance from the camera and the camera positions for each image to determine the list of GPS coordinates for the one or more objects of interest.

In a particular embodiment, using context information extracted from Open Street Map (OSM) data to refine the generated list from the MRF module includes using one or more predefined rules for a geographic relationship of an identified shape in the OSM data and an object class of the one or more objects of interest to modify the list of GPS coordinates for the one or more objects of interest. In one example embodiment, the identified shape is a road and the one or more predefined rules indicates that an object of interest cannot be located in the middle of the road. In another example embodiment, the identified shape is a building and the one or more predefined rules indicates that an object of interest cannot be located around the edge of the building.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF DRAWINGS

FIG. 1 is an example of a street view image with its metadata overlaid;

FIG. 2 is an illustration of images associated with the method of the present disclosure;

FIG. 3 is an input image representation;

FIG. 4A is an image showing positive intersections from MRF;

FIG. 4B is an image showing the results after clustering process;

FIG. 5 is a first table (Table 1) showing the impact of metadata correction;

FIG. 6 is a second table (Table 2) showing a comparison with other methods;

FIG. 7A is an image shows a prior map information overlaid on an aerial image; and

FIG. 7B is an image showing yellow does that are positives taken from image metadata and blue dots representing their corrected versions with SfM.

### DETAILED DESCRIPTION

The terminology used herein for the purpose of describing particular examples is not intended to be limiting for further examples. Whenever a singular form such as “a”, “an” and “the” is used and using only a single element is neither explicitly nor implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

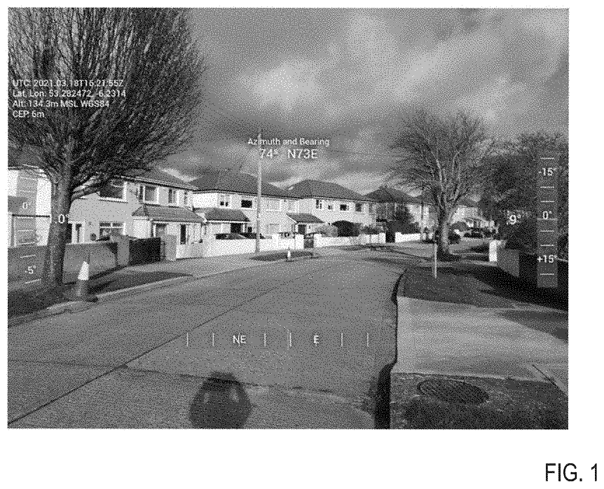

Exemplary methods, apparatuses, and computer program products for context aware geotagging in accordance with the present disclosure are described with reference to the accompanying drawings, beginning with FIG. 1.

In this disclosure, a method is disclosed to improve a pipeline by (1) denoising the camera metadata using Structure from Motion (SfM) and (2) using contextual information extracted from Open Street Map (OSM) to push the predictions to a more probable area where the objects should be situated based on road and building locations.

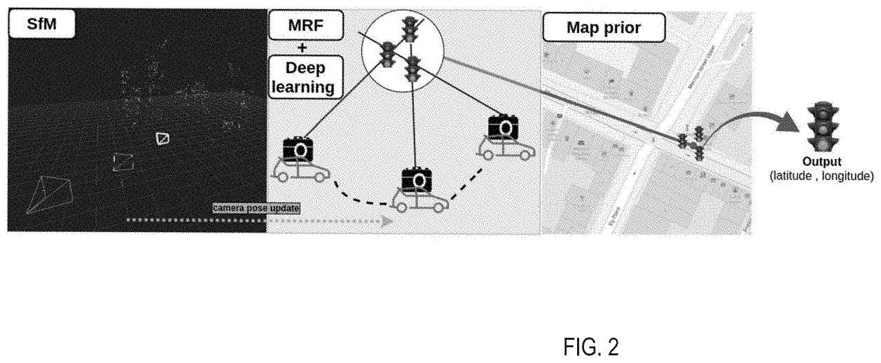

For further explanation, FIG. 2 sets forth an illustration of images associated with the method of the present disclosure. In the example of FIG. 2, the method contributions are summarized and the method has been validated for traffic light geolocation. In the example of FIG. 2, in pre-processing, SfM aims to de-noise camera medadata (i.e. poses) used as an input of the MRF. In the example of FIG. 2, in post-processing, the Map prior module refines the result from MRF using contextual information from OSM.

Camera Geolocalization:

Various Simultaneous Localization and Mapping (SLAM) and SfM techniques have been proposed to infer 3D points and to estimate the motion from a set of images (see for example (Bryan Klingner, David Martin, and James Roseborough. Street view motion-from-structure-from-motion. In Proceedings of the IEEE International Conference on Computer Vision, pages 953-960, 2013; Akihiko Torii, Michal Havlena, and Tomáš Pajdla. From google street view to 3d city models. In 2009 IEEE 12th International Conference on Computer Vision Workshops, ICCV Workshops, pages 2188-2195. IEEE, 2009; Mark Cummins. Highly scalable appearance-only slam-fab-map 2.0. Proc. Robotics: Sciences and Sys-tems (RSS), 2009, 2009; Taehee Lee. Robust 3d street-view reconstruction using sky motion estimation. In 2009 IEEE 12th International Conference on Computer Vision Workshops, ICCV Workshops, pages 1840-1847. IEEE, 2009; Jared Heinly, Johannes L Schonberger, Enrique Dunn, and Jan-Michael Frahm. Reconstructing the world* in six days*(as captured by the yahoo 100 million image dataset). In Proceedings of the IEEE Conference on Computer Vision and Pattern Recognition, pages 3287-3295, 2015.)

Bundle adjustment (BA) is integrating matched points within a sequence of images and finding a solution simultaneously optimal with respect to both camera parameters and 3D points. Agarwal (Sameer Agarwal, Noah Snavely, Steven M Seitz, and Richard Szeliski. Bundle adjustment in the large. In European conference on computer vision, pages 29-42. Springer, 2010) is first to propose the bundle adjustment that is used in the structure from motion. The trajectory of camera pose estimation is based on relative measurements, error accumulation over time thus leads to drift. Lhuillier (Maxime Lhuillier. Fusion of gps and structure-from-motion using constrained bundle adjustments. In CVPR 2011, pages 3025-3032. IEEE, 2011) proposed to use GPS geotag in the bundle adjustment optimization. A similar problem is the camera re-localization (see Li Yu, Cyril Joly, Guillaume Bresson, and Fabien Moutarde. Monocular urban localization using street view. In 2016 14th International Conference on Control, Automation, Robotics and Vision (ICARCV), pages 1-6. IEEE, 2016; and Pratik Agarwal, Wolfram Burgard, and Luciano Spinello. Metric localization using google street view. In 2015 IEEE/RSJ International Conference on Intelligent Robots and Systems (IROS), pages 3111-3118. IEEE, 2015). A GPS tag and SfM technique are used to geo-localize a street view image by estimating its relative pose against images from a database. Bresson et al. (Guillaume Bresson, Li Yu, Cyril Joly, and Fabien Moutarde. Urban localization with street views using a convolutional neural network for end-to-end camera pose regression. In 2019 IEEE Intelligent Vehicles Symposium (IV), pages 1199-1204. IEEE, 2019) and Kendall et and al. (Alex Kendall, Matthew Grimes, and Roberto Cipolla. Posenet: A convolutional network for real-time 6-dof camera relocalization. In Proceedings of the IEEE international conference on computer vision, pages 2938-2946, 2015) proposed to employ a CNN (Convolution Neural Network) features to estimate camera pose transformation.

Object Geotagging:

Qin et al. (Zengyi Qin, Jinglu Wang, and Yan Lu. Triangulation learning network: from monocular to stereo 3d object detection. IEEE Conference on Computer Vision and Pattern Recognition (CVPR), 2019; and Zengyi Qin, Jinglu Wang, and Yan Lu. Monogrnet: A geometric reasoning network for monocular 3d object localization. In Proceedings of the AAAI Conference on Artificial Intelligence, volume 33, pages 8851-8858, 2019) proposed to estimate the instance-level depth of objects in images as an alternative to pixel-wise depth estimation. They found out the latter (obtained by minimizing the mean error for all pixels) sacrifices the accuracy of certain local areas in images. Bertoni et al. (Lorenzo Bertoni, Sven Kreiss, and Alexandre Alahi. Monoloco: Monocular 3d pedestrian localization and uncertainty estimation. In Proceedings of the IEEE/CVF International Conference on Computer Vision, pages 6861-6871, 2019) employed a prior knowledge of the average height of humans to perform pedestrian localization. Qu et al. (Xiaozhi Qu, Bahman Soheilian, and Nicolas Paparoditis. Vehicle localization using mono-camera and geo-referenced traffic signs. In 2015 IEEE Intelligent Vehicles Symposium (IV), pages 605-610. IEEE, 2015) proposed to detect and locate traffic signs from a monocular video stream. They relied on bundle adjustment with image GPS geo-tag to reconstruct a sparse point cloud as a 3D map, then align it with several landmarks from the 3D city model generated by Soheilian et al. (Bahman Soheilian, Olivier Tournaire, Nicolas Paparoditis, Bruno Vallet, and Jean-Pierre Papelard. Gen-eration of an integrated 3d city model with visual landmarks for autonomous navigation in dense urban areas. In 2013 IEEE Intelligent Vehicles Symposium (IV), pages 304-309. IEEE, 2013).

Wegner et al. (Jan D Wegner, Steven Branson, David Hall, Konrad Schindler, and Pietro Perona. Cataloging public ob-jects using aerial and street-level images-urban trees. In Proceedings of the IEEE Conference on Computer Vision and Pattern Recognition, pages 6014-6023, 2016) proposed a probabilistic model to locate trees. They employed multiple modalities, including aerial view semantic segmentation, street view detection, map information as well as the tree distance prior. Information is fused into a conditional random field (CRF) to predict the positions of trees. However, identical features may be mismatched in case the recurring objects sit nearby. To solve this issue, Nassar et al. (Ahmed Samy Nassar, Nico Lang, Sébastien Lefèvre, and Jan D Wegner. Learning geometric soft constraints for multi-view instance matching across street-level panoramas. In 2019 Joint Urban Remote Sensing Event (JURSE), pages 1-4. IEEE, 2019; and Ahmed Samy Nassar, Sébastien Lefèvre, and Jan Dirk Wegner. Multi-view instance matching with learned geometric soft-constraints. ISPRS International Journal of Geo-Information, 9(11):687, 2020) employed the soft geometry constraint on geo-location of camera pose to identify a same object that appears in two views. They concatenate camera pose information together with image features and decode them using a CNN. The same object in first view can be re-identified in the second view.

Nassar et al. (Ahmed Samy Nassar, Stefano D'Aronco, Sébastien Lefèvre, and Jan D Wegner. Geograph: Graph-based multi-view object detection with geometric cues end-to-end. In European Conference on Computer Vision, pages 488-504. Springer, 2020) extended the method by constructing a graph from detected bounding boxes across the multi-views, feed the graph to a GNN (Thomas N Kipf and Max Welling. Semi-supervised classification with graph convolutional networks. arXiv preprint arXiv: 1609.02907, 2016) and let the GNN identify the same objects across different views. Hebbalaguppe. et al. (Ramya Hebbalaguppe, Gaurav Garg, Ehtesham Hassan, Hiranmay Ghosh, and Ankit Verma. Telecom inventory management via object recognition and localisation on google street view images. In 2017 IEEE Winter Conference on Applications of Computer Vision (WACV), pages 725-733. IEEE, 2017) predicted bounding boxes around street objects, which was followed by the two-view epipolar constraint to reconstruct 3D feature points from the two observed scenes. However, the 3D feature point does not necessarily fall inside the target bounding box. Krylov et al. (Vladimir A. Krylov, Eamonn Kenny, and Rozenn Dahyot. Automatic discovery and geotagging of objects from street view imagery. Remote Sensing, 10(5), 2018) employed the camera pose from multiple views as a soft constraint and used semantic segmentation of images alongside a monocular depth estimator to extract the information (bearing and depth) about objects of interest, and feeds the obtained information into an MRF model that predicts their locations.

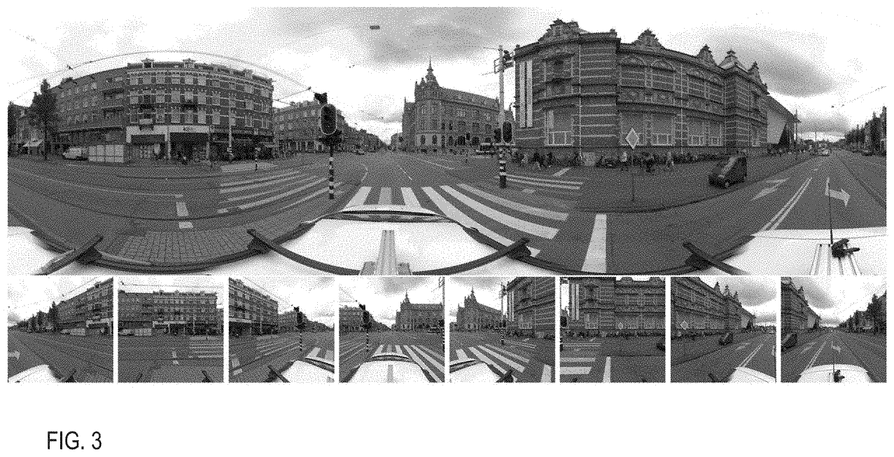

For further explanation, FIG. 3 sets forth an input image representation. In the example of FIG. 3, an input image representation consists of 8 overlapping rectilinear views split from a 360° field of view panorama. The image in FIG. 3 was acquired from Mapillary API (www.mapillary.com)

Methods:

The present disclosure presents camera calibration using the SfM technique in Section 3.1, which provides a higher quality information to be used as an input to the MRF presented in Section 3.2. Section 3.3 proposes a post-processing method to refine the MRF predictions.

3.1 Structure from Motion: Using Optical Observation to Denoise on GPS Data

The input represents a set of N panoramic street view images (360° field of view) captured with their metadata in an area of interest. Accurate camera geo-location is a key to accurately geo-locate objects in the scene. The GPS position in the metadata is inherently noisy, which lowers the accuracy for predicting object positions. To get a better estimate of the GPS coordinates associated with each camera position, we propose to tune each of the camera positions with a conventional 3D reconstruction pipeline (see Alex M Andrew. Multiple view geometry in computer vision. Kybernetes, 2001), followed by bundle adjustment (Sameer Agarwal, Noah Snavely, Steven M Seitz, and Richard Szeliski. Bundle adjustment in the large. In European conference on computer vision, pages 29-42. Springer, 2010). To ease image matching, the disclosure splits the 360° panorama views into 8 overlapping rectilinear views: each view covers a 90-degree field of view and is overlapped by 45 degrees in the horizontal direction. Each view is then considered as an image captured by a pinhole camera, free of distortion (see FIG. 3).

The disclosure aims to find all possible matching features extracted from the images and perform camera calibration to adjust the camera pose from image metadata.

Note the set of rectilinear views ₁V={v₈⁽ⁱ⁾, . . . , v⁽ⁱ⁾}ᵢ₌₁_{₁}_{, . . . , N} where v⁽ⁱ⁾, . . . , v⁽ⁱ⁾ corresponds to rectilinear views associated with panorama i=1, . . . , N (N=112 in this experiment). Suppose two views are matched by their detected features. The epipolar constraint with 5 point algorithm (see Alex M Andrew. Multiple view geometry in computer vision. Kybernetes, 2001) is applied to find the essential matrix E which establishes the geometry relationship between two views. E can be further decomposed into translation and rotation matrix, noted as R and τ, respectively. They can be put together as a transformation matrix Θ∈SE(3)

$$Θ = \begin{matrix}R & T \\ 0 & 1\end{matrix} ∈ {R}^{4 \times 4}$$

with R∈S̅O̅(3) and τ∈R³.

Each calibrated view in Vis associated with θ=(R, τ), these parameters can be estimated by minimizing the re-projection error from 3D feature space to 2D image plane within a bundle of images.

3.2 Object Geolocation with MRF

The MRF model performs binary decisions on the nodes of a 2D graph, each node corresponding to an inter-section between two rays. The rays correspond to rays (in 2D) with origins the camera GPS coordinates and with directions the bearings associated with the segmented object of interest (the pixel in the middle of the segmented object is chosen for the bearing information). The objects of interest are segmented using a deep learning pipeline that also estimates their distances (from the camera) (see Vladimir A. Krylov, Eamonn Kenny, and Rozenn Dahyot. Automatic discovery and geotagging of objects from street view imagery. Remote Sensing, 10(5), 2018). Each camera view provides one or many rays shooting to the objects of interest. The MRF model is optimized to perform a binary decision for each node concerning its occupancy by the object of interest (i.e. 0=no object, 1=object present). For more information, please refer to (Vladimir A. Krylov, Eamonn Kenny, and Rozenn Dahyot. Automatic discovery and geotagging of objects from street view imagery. Remote Sensing, 10(5), 2018). The present disclosure provides more accurate GPS coordinates for the camera positions (than originally available in the image metadata) thanks to SfM, hence improving the geo-location of the nodes on this MRF and ultimately improving the accuracy of GPS coordinates for the objects of interest.

3.3 Post-Processing

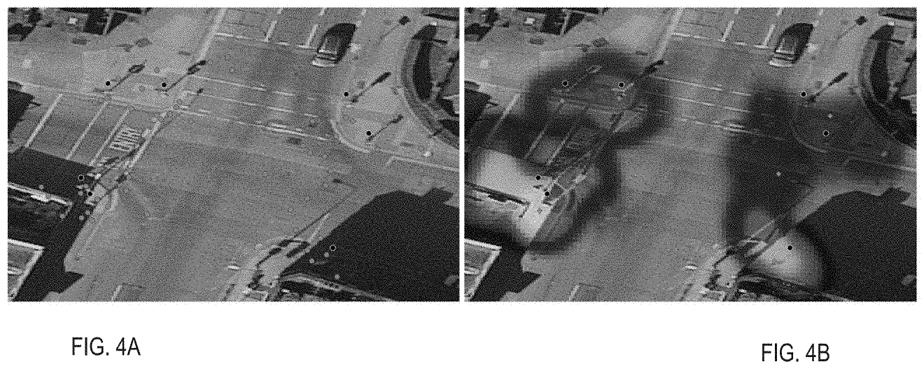

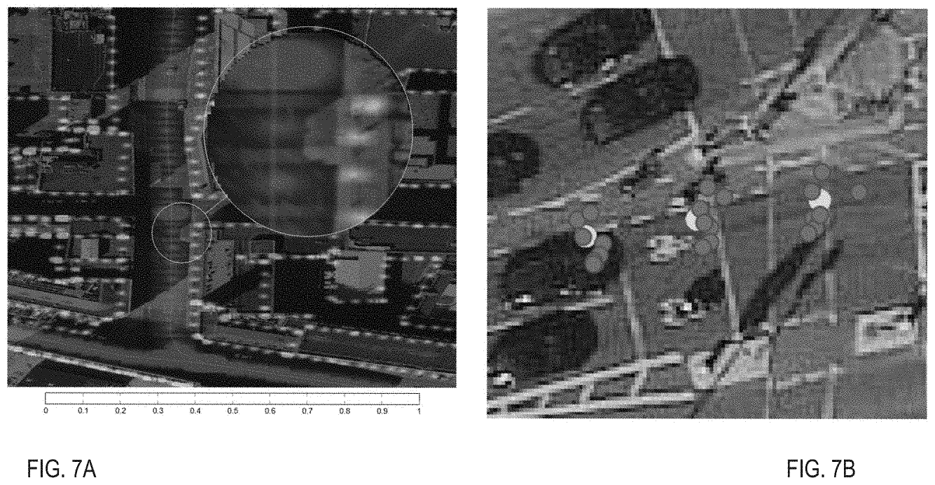

Because of the inaccuracies of the rays that define the MRF nodes, the same object may be associated with multiple nodes (See FIG. 4A) located in the same vicinity on the MRF graph. To resolve this issue Krylov et al. (Vladimir A. Krylov, Eamonn Kenny, and Rozenn Dahyot. Automatic discovery and geotagging of objects from street view imagery. Remote Sensing, 10(5), 2018) added a hierarchical clustering step after optimizing the MRF to merge close positive sites together. The final position is the average of sites in the cluster. However, some of the positive sites were situated at improbable areas, for example, in the middle of the road. Therefore, the present disclosure proposes to use OSM data to act as a useful prior for an area. As the objects of interest (e.g. traffic lights) are static and are located on a side of the road, the disclosure applies the following rule: the object of interest can not be located in the middle of the road, or around the edge of a building. The OSM data has building, and road classes represented by polygons and lines, respectively. A Normal kernel is fitted at each OSM node (cf FIG. 7A, 7B). Suppose a cluster C containing n positive sites C=[c₁, c₂, . . . , cₙ], W(x) is the function to query the weight that corresponds to the particular site in C and depends on the OSM nodes Nₓ within the close proximity of the site x. The position P (equation 2) can be refined using a weighted average where certain sites are penalized with small weights.

$$W ( x ) = 1 - min \begin{matrix}( L \\ 1 , μσϵ \\ N\end{matrix} - exp \frac{{-}^{( (} x - {μ}^{2}}{2} and P = \text{?} \qquad ( 2 )$$

$$\text{?} \text{indicates text missing or illegible when filed}$$

The σ stands for the standard deviation in meters and the μ is the node centre obtained from the OSM data. The σ is set to 2 meters for roads and 1 meter for building edges. The resolution of the Gaussian grid is 25 centimeters.

3.4 Implementation

SURF descriptors (Herbert Bay, Andreas Ess, Tinne Tuytelaars, and Luc Van Gool. Speeded-up robust features (surf). Computer vision and image understanding, 110(3):346-359, 2008) are used and in each view, 6,000 features are extracted. We employ FLANN (Fast Library for Approximate Nearest neighbors (Marius Muja and David G Lowe. Fast matching of binary features. In 2012 Ninth conference on computer and robot vision, pages 404-410. IEEE, 2012) to match the SURF features between rectilinear views. RANSAC is used to remove outliers. We use the OpenSfM (https://github.com/mapillary/OpenSfM) to calibrate camera poses and Crese (Sameer Agarwal, Noah Snavely, Steven M Seitz, and Richard Szeliski. Bundle adjustment in the large. In European conference on computer vision, pages 29-42. Springer, 2010) as our solver to optimize the Θ. As the nodes from raw OSM data are not equally distributed, we interpolate the nodes every 5 meters in QGIS (https://www.qgis.org/en/site/) to get a dense distribution of the map prior.

Experimental Results

To validate our approach, we have used 896 GSV images (112 panoramas split into 8 images each) collected in Dublin city center. The object of interest corresponds to a traffic light. We fine-tuned the input camera poses using the SfM (cf. FIG. 7A, FIG. 7B). The disclosure corrected the bearing and position information on average by 4.36 degrees and 0.71 meters respectively. Moreover, the use of the OSM prior results in an average refinement of the prediction by 0.17 meters.

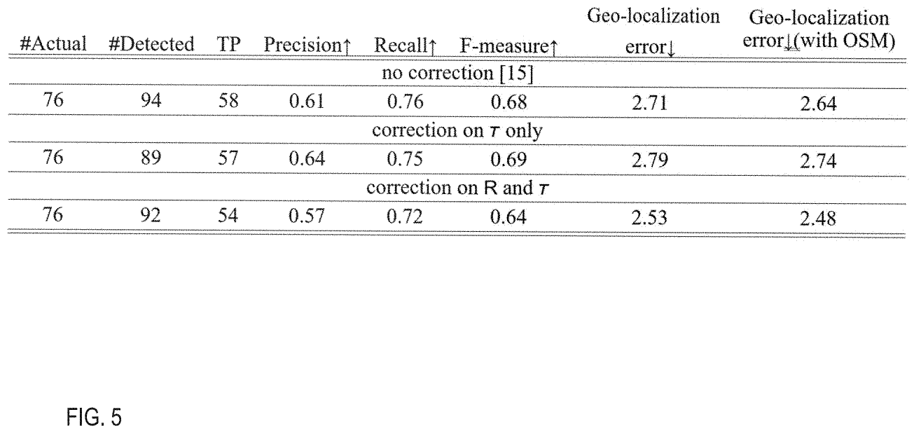

For further explanation, FIG. 5 sets forth a first table (Table 1) showing the impact of metadata correction. In the example of Table 1, the disclosure evaluates the impact of metadata correction by a comparison with results that do not use any pose correction. By correcting the full camera pose (R and τ), the geo-location accuracy reaches error of around 2.5 meters to a reference point. It outperforms the result with no correction by 18 cm, and 16 cm after applying the OSM prior. We reach the highest F-measure if only the τ is corrected.

By using the disclosure's SFM module we can check the impact of the following correction of the metadata: correction on τ only (i.e. GPS location of the camera), correction on R and τ (i.e. correction of both GPS location and bearing of the camera). To validate our approach, the disclosure uses the original metadata as our baseline for comparisons. Table 1 shows the testing results in terms of geo-localization error and precision and recall detection metrics. Traffic lights are considered to be recovered accurately (true positive) if they are located within 6 meters from the reference position, otherwise it is viewed as a false positive. The geo-localization error measures the average Haversine distance between the prediction and its reference target in meters. A small distance indicates accurate position prediction.

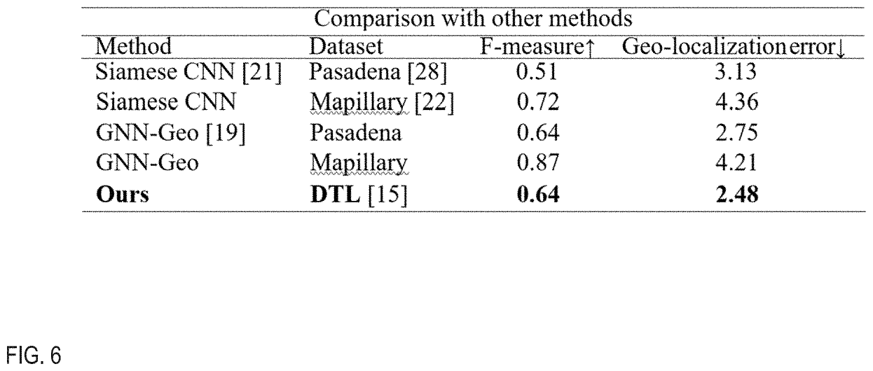

For further explanation, FIG. 6 sets forth a second table (Table 2) showing a comparison with other methods. In the example of Table 2, we compare our results with related public asset geo-location approaches. The proposed technique reaches the smallest positional error, however, the results are not directly comparable due to the different complexity of the scene and detected objects.

In the example of Table 2, in comparison with other approaches, the disclosure's method achieves the smallest geo-localization error, although the other datasets might be more challenging for object detection.

### CONCLUSION

We have shown that by denoising metadata associated with street view imagery using SfM, and by using context information such as road and building shapes extracted from OSM, assets of interest can be geolocalized with higher accuracy. Currently, our pipeline is geotagging one class of objects at a given time, and future work will investigate multiple static object class tagging with additional priors associated with their relative positioning in the scene, to improve further geolocation accuracy.

Exemplary embodiments of the present invention are described largely in the context of a fully functional computer system for context aware object geotagging. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, an apparatus, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or other devices to cause a series of operational steps to be performed on the computer, other programmable apparatuses or other devices to produce a computer implemented process, such that the instructions which execute on the computer, other programmable apparatus, or other device implement the functions/acts specified in the disclosure.

While particular combinations of various functions and features of the one or more embodiments are expressly described herein, other combinations of these features and functions are likewise possible. The present disclosure is not limited by the particular examples disclosed herein and expressly incorporates these other combinations.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of context aware geotagging of objects, the method comprising:
receiving a set of N panoramic images captured with metadata associated with each image, the metadata for an image indicating a camera position of a camera;
denoising the metadata associated with at least one of the images;
providing the denoised metadata to a Markov Random Field (MRF) module to generate a list of GPS coordinates for one or more objects of interest; and
using context information extracted from Open Street Map (OSM) data to refine the generated list from the MRF module.

2. The method of claim 1, wherein denoising the metadata includes:
splitting each panoramic image into at least two images with overlapping views;
identifying matching features extracted from the split panoramic images; and
using the identified matching features to calibrate the camera positions of the split images.

3. The method of claim 2, wherein using the identified matching features to calibrate the camera positions of the split images includes:
establishing a geometry relationship between at least two split images.

4. The method of claim 2, wherein using the identified matching features to calibrate the camera positions of the split images includes:
adjusting at least one of bearing information and position information associated with the split image.

5. The method of claim 1 wherein providing the denoised metadata to the MRF module to generate the list of GPS coordinates for the one or more objects of interest includes:
using a deep learning pipeline to segment the one or more objects of interest and estimate their distance from the camera; and
using the estimated distance from the camera and the camera positions for each image to determine the list of GPS coordinates for the one or more objects of interest.

6. The method of claim 1 wherein using context information extracted from Open Street Map (OSM) data to refine the generated list from the MRF module includes:
using one or more predefined rules for a geographic relationship of an identified shape in the OSM data and an object class of the one or more objects of interest to modify the list of GPS coordinates for the one or more objects of interest.

7. The method of claim 6 wherein the identified shape is a road and the one or more predefined rules indicates that an object of interest cannot be located in the middle of the road.

8. The method of claim 6 wherein the identified shape is a building and the one or more predefined rules indicates that an object of interest cannot be located around the edge of the building.

9. An apparatus for context aware geotagging of objects, the apparatus comprising a computer processor and computer readable storage medium that includes computer program instructions that when executed by the computer processor cause the computer processor to carry out the operations of:
receiving a set of N panoramic images captured with metadata associated with each image, the metadata for an image indicating a camera position of a camera;
denoising the metadata associated with at least one of the images;
providing the denoised metadata to a Markov Random Field (MRF) module to generate a list of GPS coordinates for one or more objects of interest; and
using context information extracted from Open Street Map (OSM) data to refine the generated list from the MRF module.

10. The apparatus of claim 9, wherein denoising the metadata includes:
splitting each panoramic image into at least two images with overlapping views;
identifying matching features extracted from the split panoramic images; and
using the identified matching features to calibrate the camera positions of the split images.

11. The apparatus of claim 10, wherein using the identified matching features to calibrate the camera positions of the split images includes:
establishing a geometry relationship between at least two split images.

12. The apparatus of claim 10, wherein using the identified matching features to calibrate the camera positions of the split images includes:
adjusting at least one of bearing information and position information associated with the split image.

13. The apparatus of claim 9, wherein providing the denoised metadata to the MRF module to generate the list of GPS coordinates for the one or more objects of interest includes:
using a deep learning pipeline to segment the one or more objects of interest and estimate their distance from the camera; and
using the estimated distance from the camera and the camera positions for each image to determine the list of GPS coordinates for the one or more objects of interest.

14. The apparatus of claim 9 wherein using context information extracted from Open Street Map (OSM) data to refine the generated list from the MRF module includes:
using one or more predefined rules for a geographic relationship of an identified shape in the OSM data and an object class of the one or more objects of interest to modify the list of GPS coordinates for the one or more objects of interest.

15. The apparatus of claim 14, wherein the identified shape is a road and the one or more predefined rules indicates that an object of interest cannot be located in the middle of the road.

16. The apparatus of claim 14 wherein the identified shape is a building and the one or more predefined rules indicates that an object of interest cannot be located around the edge of the building.

17. A computer readable storage medium for context aware geotagging of objects, the computer readable storage medium includes computer program instructions that when executed by a computer processor cause the computer processor to carry out the operations of:
receiving a set of N panoramic images captured with metadata associated with each image, the metadata for an image indicating a camera position of a camera;
denoising the metadata associated with at least one of the images;
providing the denoised metadata to a Markov Random Field (MRF) module to generate a list of GPS coordinates for one or more objects of interest; and
using context information extracted from Open Street Map (OSM) data to refine the generated list from the MRF module.

18. The computer readable storage medium of claim 17, wherein denoising the metadata includes:
splitting each panoramic image into at least two images with overlapping views;
identifying matching features extracted from the split panoramic images; and
using the identified matching features to calibrate the camera positions of the split images.

19. The computer readable storage medium of claim 18, wherein using the identified matching features to calibrate the camera positions of the split images includes:
establishing a geometry relationship between at least two split images.

20. The computer readable storage medium of claim 18, wherein using the identified matching features to calibrate the camera positions of the split images includes:
adjusting at least one of bearing information and position information associated with the split image.
